(19) United States
(12) Patent Application Publication
(10) Pub. No.: US 2015/0067223 A1
(43) Pub. Date: Mar. 5, 2015

(54) HOT SWAPPABLE MEMORY MOTHERBOARD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: GUI-FU XIAO, Shenzhen (CN); CHENG-FEI WENG, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/092,933

(22) Filed: Nov. 28, 2013

(30) Foreign Application Priority Data
Sep. 2, 2013 (CN) 2013103913680

(51) Int. Cl. G06F 13/40

(52) U.S. Cl. CPC G06F 13/4081
USPC 710/302

(57) ABSTRACT

A hot swappable memory motherboard includes a center processor unit and a memory unit. A button is set on the motherboard. Pressing the button, a signal is sent to the center processor unit to stop operating the memory unit.

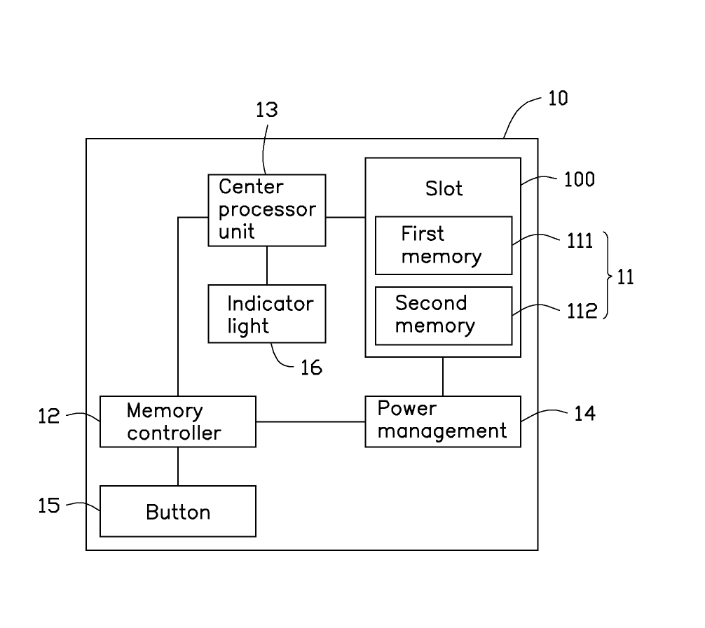

### BACKGROUND

1. Technical Field

The present disclosure relates to motherboards of computers and, particularly, to a hot swappable memory motherboard.

2. Description of Related Art

Hot swappable devices are used widely, for hot swappable hard disks, hot swappable power sources, or hot swappable USB, for example. Among these devices, hot swappable USB is most widely used.

When motherboards including memory cards are tested, memory cards are needed to unplug or plug in within some test items. But the memory cards of a motherboard are not hot swappable, power of the motherboard must power off then the memory cards are unplugged or plugged in. If the memory cards are directly plugged from the motherboard not only the memory cards can be damaged but also the motherboard could collapse.

Therefore, it is desirable to provide a hot swappable memory motherboard which can overcome the limitation described.

### BRIEF DESCRIPTION OF THE DRAWINGS

The components of the drawing are not necessarily drawn to scale, the emphasis instead being placed upon clearly illustrating the principles of the embodiments of the present disclosure. Moreover, in the drawing, like reference numerals designate corresponding parts throughout several views.

The FIGURE is a schematic view of a hot swappable memory motherboard, according to an exemplary embodiment of the present disclosure.

### DETAILED DESCRIPTION

The FIGURE shows an exemplary embodiment of a hot swappable memory motherboard 10. The motherboard 10 includes a memory unit 11, a memory controller 12, a center processor unit 13, a power management 14, a button 15, and an indicator light 16. The button 15 is configured for hot swapping the memory unit 11 when the motherboard 10 is not powered off.

The motherboard 10 includes a slot 100 for plugging into the memory card 11. In this embodiment, the memory unit 11 includes a first memory 111 and a second memory 112. In other embodiment, a number of the memory card 11 can be one, three, or more than three.

The memory controller 12 is connected with the center processor unit 13, the power management 14, and the button 15. The power management 14 is configured for applying power energy to all of the memory unit 11, the center processor unit 13, and the memory controller 12. The button 15 is connected with the memory controller 12 through a system bus, for example General Purpose Input Output (GPIO) bus.

The memory controller 12 can be integrated in the center processor unit 13. The button 15 can be set on the motherboard 10 or the memory unit 11. In this embodiment, the button 15 includes two, one is set on the first memory 111, and the other is set on the second memory 112.

When the first memory 111 is hot swapped, the button 15 on the first memory 111 is pressed. A low-level control signal is sent to the memory controller 12 through the system bus. The memory controller 12 notifies the center processor unit 11 and the power management 14. The center processor unit 11 stops exchanging data with the first memory 111 in order that the first memory 111 is ready to be unplugged from the slot 100. At the same time, the power management 13 cuts off the power energy applied to the first memory 111. The indicator light 16 is controlled to power on by the center processor unit 13. Then the first memory 111 can be hot swapped from the slot 100 while the power management 14 is still powered on. In other words, the motherboard 10 is still powered on.

Process of hot swapping the second memory 112 is the same as process of hot swapping the first memory 111.

When the center processor unit 13 operates the first memory 111 to read and write, the second memory 112 also reads and writes under control of the center processor unit 13. The second memory 112 has same data with the first memory 111, thus the second memory 112 can be a copy as the first memory 111. Even if the first memory 111 is damaged, the data can be taken from the second memory 112.

Hot swapping the first memory 111 or the second memory 112, the button 15 is pressed. The center processor unit 13 stops operating the first memory 111 or the second memory 112. The first memory 111 or the second memory 112 can be hot swapped from the slot 100 but the power management 14 of the motherboard 10 still works normally.

Additionally, the first memory 111 and the second memory 112 have the same data, the first memory 111 and the second memory 112 are copies as each other, so stabilization of hot swapping of the memory unit 11 of the motherboard 10 enhances.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely exemplary embodiments of the disclosure.

What is claimed is:

1. A hot swappable memory motherboard, comprising a center processor unit and a memory unit, wherein, a button is set on the motherboard, when pressing the button, a signal is sent to the center processor unit to stop operating the memory unit.

2. The hot swappable memory motherboard of claim 1, wherein a memory controller is integrated in the center processor unit, the button is connected with the memory controller.

3. The hot swappable memory motherboard of claim 2, wherein the button is connected with the memory controller through general purpose input output bus.

4. The hot swappable memory motherboard of claim 1, comprising a power management unit configured for applying power energy to the center processor unit and the memory unit.

5. The hot swappable memory motherboard of claim 1, comprising an indicator light connected with the center processor unit.

6. The hot swappable memory motherboard of claim 1, wherein the memory unit comprises a first memory and a second memory, the center processor unit operates the first memory and the second memory at the same time, such that the first memory has the same data as the second memory.

7. The hot swappable memory motherboard of claim 6, wherein the button comprises two, one is set on the first memory and the other is set on the second memory.
